(19) United States
(12) Patent Application Publication
(10) Pub. No.: US 2025/0293438 A1
(43) Pub. Date: Sep. 18, 2025

(54) ANTENNA, ANTENNA ARRAY, AND COMMUNICATION DEVICE

(71) Applicant: HUAWEI TECHNOLOGIES CO., LTD., Shenzhen (CN)

(72) Inventors: Jingzhou Li, Hangzhou (CN); Xin LI, Hangzhou (CN); Hongxing Dong, Hangzhou (CN); xizhe Liang, Hangzhou (CN); Haocheng Tang, Hangzhou (CN); Dong Liang, Shenzhen (CN); long zhang, Hangzhou (CN)

(73) Assignee: HUAWEI TECHNOLOGIES CO., LTD., Shenzhen (CN)

(21) Appl. No.: 19/222,188

(22) Filed: May 29, 2025

Related U.S. Application Data
(63) Continuation of application No. PCT/CN2022/135715, filed on Nov. 30, 2022.

(51) Int. Cl. H01Q 15/02

(52) U.S. Cl. CPC H01Q 15/02

(57) ABSTRACT

An antenna includes a base body and a fluorescent body. The base body includes a first end face and a second end face that are oppositely provided, and the base body shrinks from the first end face toward the second end face. A plurality of holes that penetrate the first end face and the second end face are provided in the base body, the plurality of holes surround an outer periphery of a first area in the base body, and both the first area surrounded by the plurality of holes in the base body and each of the holes shrink from the first end face toward the second end face.

### CROSS-REFERENCE TO RELATED APPLICATIONS

This application is a continuation of International Application No. PCT/CN2022/135715, filed on Nov. 30, 2022, the disclosure of which is hereby incorporated by reference in its entirety.

### STATEMENT OF JOINT RESEARCH AGREEMENT

The subject matter and the claimed invention were made by or on the behalf of Hangzhou Institute for Advanced Study, UCAS, P.R. China and Huawei Technologies Co., Ltd., of Shenzhen, Guangdong Province, P.R. China, under a joint research agreement titled “Research on Fluorescent Antenna and Prototype Development of Chi-based Superlattice Materials”. The joint research agreement was in effect on or before the claimed invention was made, and that the claimed invention was made as a result of activities undertaken within the scope of the joint research agreement.

### TECHNICAL FIELD

The present disclosure relates to the field of antenna technologies, and in particular, to an antenna, an antenna array, and a communication device.

### BACKGROUND

With development of the Internet of Things, a data transmission rate of wireless communication is facing great challenges. Mobile communication based on microwaves and millimeter waves cannot achieve a larger data throughput due to strained spectrum resources. Optical communication features a wide frequency band, a large communication capacity, and a strong anti-electromagnetic interference capability.

Currently, most fluorescent antennas for receiving light waves are of planar fluorescent waveguide structures. An upper surface of the planar fluorescent waveguide structure receives incident light and conducts the light to a fluorescent body through a light guide column. After absorbing a light wave, the fluorescent body emits the light wave and then conducts the sent light wave to a side surface. A light conduction process of the planar fluorescent waveguide structure is complex, and a possibility that the light escapes from the antenna is increased. After receiving the light, the fluorescent body needs to emit the light wave, and further needs to conduct the light. Therefore, when conducting the light, the fluorescent body absorbs light emitted by the fluorescent body. As a result, the planar fluorescent waveguide structure has a poor light concentration capability and low light utilization. In addition, the planar fluorescent waveguide structure does not match a photosensitive surface of a high-speed detector. As a result, the efficiency of coupling between the planar fluorescent waveguide structure and the detector is not high.

### SUMMARY

In one embodiment of the present disclosure, an antenna, an antenna array, and a communication device are provided, so that a light receiving capability and a light concentration capability that are of the antenna can be enhanced, to improve efficiency of transmitting a light wave by the antenna.

According to first aspect, an embodiment of the present disclosure provides an antenna. The antenna includes a base body and a fluorescent body. The base body includes a first end face and a second end face that are oppositely disposed, and the base body shrinks (become smaller) from the first end face toward the second end face; and a plurality of holes that penetrate the first end face and the second end face are provided in the base body, the plurality of holes surround an outer periphery of a first area in the base body, and both the first area surrounded by the plurality of holes in the base body and each of the holes shrink from the first end face toward the second end face. The fluorescent body is provided in at least a part of the plurality of holes.

After incident light enters the base body or after the fluorescent body receives incident light and then emits the light to enter the base body, because the base body shrinks from the first end face to the second end face, a reflection probability of the light in the base body can be increased, to improve incident light utilization of the antenna.

The plurality of holes surround the first area in the base body, the first area in the base body is a fiber core, and an area at an outer periphery of the fiber core in the base body is a cladding layer. The fiber core has no hollow structure, so that a refractive index of the fiber core is greater than a refractive index of the cladding layer. Using the fiber core to transmit a light wave can increase a reflection probability of the light wave during transmission in the fiber core, to improve an overall light concentration capability of the antenna. The plurality of holes are at the outer periphery of the fiber core. It can be learned that the fluorescent body is located at the outer periphery of the fiber core. After the fluorescent body receives incident light and then emits a light wave, the light wave emitted by the fluorescent body enters the fiber core. Because the refractive index of the fiber core is greater than the refractive index of the cladding layer, the light entering the fiber core is not easy to escape from the antenna. In this way, the overall light concentration capability of the antenna for transmitting the light wave can be improved. The plurality of holes are provided on the cladding layer, and the overall refractive index of the cladding layer can be adjusted by adjusting and controlling a quantity of holes on the cladding layer, sizes of the holes, and spacings between adjacent holes.

With reference to the first aspect, in a possible implementation, a refractive index of the fluorescent body is less than a refractive index of the base body. After entering the base body, the light wave is not easy to escape from the base body to the fluorescent body, so that a light concentration capability of the base body can be improved.

With reference to the first aspect, in a possible implementation, the antenna further includes a light concentration member connected to the first end face, and a second area projected by the light concentration member onto the first end face covers the plurality of holes and the first area surrounded by the plurality of holes in the base body. The light concentration member is one of a light concentration lens, a microstructure lens array, or a lens having a microstructure array. Because the light concentration member is one of the light concentration lens, the microstructure lens array, or the lens having the microstructure array, a light receiving field of view of the antenna can be increased.

With reference to the first aspect, in a possible implementation, the light concentration member includes a fluorescent material. When the light concentration member receives the incident light, the fluorescent material in the light concentration member can capture the incident light, and then emit a new light wave whose wavelength is greater than that of the incident light, so that the light concentration member does not follow conservation of optical etendue. In this way, not only the light receiving field of view of the antenna can be increased, but also a light receiving flux of the first end face in the base body can be increased.

According to a second aspect, this disclosure provides another antenna. The antenna includes a base body and a light concentration member. The base body includes a first end face and a second end face that are oppositely provided, and the base body shrinks from the first end face toward the second end face; and a plurality of holes that penetrate the first end face and the second end face are provided in the base body, the plurality of holes surround an outer periphery of a first area in the base body, and both the first area surrounded by the plurality of holes in the base body and each of the holes shrink from the first end face toward the second end face. The light concentration member is connected to the first end face, a second area projected by the light concentration member onto the first end face covers the plurality of holes and the first area surrounded by the plurality of holes in the base body, and the light concentration member includes a fluorescent material.

The fluorescent material in the light concentration member can capture incident light, and then emit a new light wave whose wavelength is greater than that of the incident light, so that the light concentration member does not follow conservation of optical etendue. In this way, not only a light receiving field of view of the antenna can be increased, but also a light receiving flux of the first end face in the base body can be increased. Because the base body shrinks from the first end face to the second end face, a reflection probability of the light in the base body can be increased, to improve incident light utilization of the antenna. The plurality of holes surround the first area in the base body, so that the first area forms a fiber core, and an area at an outer periphery of the fiber core in the base body forms a cladding layer. The fiber core has no hollow structure, so that a refractive index of the fiber core is greater than a refractive index of the cladding layer. Using the fiber core to transmit the light wave can increase a reflection probability of the light wave during transmission in the fiber core, to improve an overall light receiving capability of the antenna. The plurality of holes are provided on the cladding layer, and the overall refractive index of the cladding layer can be adjusted by adjusting and controlling a quantity of holes on the cladding layer, sizes of the holes, and spacings between adjacent holes.

With reference to the first aspect or the second aspect, in a possible implementation, an axial cross section of the base body is one of a circle, an ellipse, or a polygon.

With reference to the first aspect or the second aspect, in a possible implementation, a busbar of the base body includes a first arc and a second arc, a first end of the first arc extends to the first end face, a second end of the first arc is connected to a first end of the second arc, and a second end of the second arc extends to the second end face. The busbar of the base body includes two connected segments: the first arc and the second arc, so that the base body can gradually shrink from the first end face to the second end face, to improve light concentration effects of the base body.

With reference to the first aspect or the second aspect, in a possible implementation, a curvature of the first arc ranges from 5 mm to 200 mm, and a curvature of the second arc ranges from 5 mm to 200 mm.

With reference to the first aspect or the second aspect, in a possible implementation, a circle center for the first arc and a circle center for the second arc are respectively on two sides of the busbar, so that the first arc and the second arc can be connected more smoothly. In this way, the reflection probability of the light during transmission in the base body is increased, to improve a light concentration capability of the base body.

With reference to the first aspect or the second aspect, in a possible implementation, a diameter of the first end face ranges from 1 mm to 200 mm, and a diameter of the second end face ranges from 20 um to 1 mm. A size of the second end face matches a size of a photosensitive surface of a detector, and a size of the first end face is far greater than the size of the second end face. This helps the antenna receive more optical signals.

With reference to the first aspect or the second aspect, in a possible implementation, an axial cross section of the first area surrounded by the plurality of holes in the base body is a circle, a diameter of the first area that is on the first end face and that is surrounded by the plurality of holes in the base body ranges from 100 μm to 800 μm, and a diameter of the first area that is on the second end face and that is surrounded by the plurality of holes in the base body ranges from 5 μm to 60 μm. The fiber core is used for transmitting most of light waves in the base body, and the fiber core gradually shrinks from the first end face to the second end face. In addition, a diameter of the fiber core on the first end face ranges from 100 μm to 800 μm, and a diameter of the fiber core on the second end face ranges from 5 μm to 60 μm. This helps the fiber core concentrate the light, and increases the reflection probability of the light wave during transmission in the fiber core and improves utilization of the optical signal.

With reference to the first aspect or the second aspect, in a possible implementation, the plurality of holes are arranged in an array, a diameter of each of the holes on the first end face ranges from 50 μm to 300 μm, and a diameter of each of the holes on the second end face ranges from 0.5 μm to 60 μm.

With reference to the first aspect or the second aspect, in a possible implementation, an anti-reflective film is disposed on a surface of the light concentration member. The anti-reflective film can increase a probability that the light concentration member absorbs the light, and can further reduce a probability that an optical signal emitted by the fluorescent material in the light concentration member escapes from the surface of the light concentration member to the outside of the antenna.

With reference to the first aspect or the second aspect, in a possible implementation, the antenna further includes a supersurface layer, and the supersurface layer is provided between the light concentration member and the second end face. The supersurface layer can adjust and control a characteristic, such as a phase or a propagation direction, of the light wave. After receiving the incident light, the light concentration member emits the new light wave or transmits the received light wave to the supersurface layer. The supersurface layer can change a transmission direction of the light wave, so that the light wave can be perpendicular to the first end face and incident to the base body, to reduce an incident angle of the light wave input to the base body, reduce a probability that the light wave is reflected on the first end face, and improve efficiency of receiving the light wave by the base body.

With reference to the first aspect or the second aspect, in a possible implementation, a plurality of metal particles arranged in an array are provided on the supersurface layer, and a distance between adjacent metal particles ranges from 50 nm to 500 nm. The array of the metal particles can change the phase and polarization that are of the light wave, so that the light wave is more easily received by the antenna, to improve efficiency of receiving the light wave by the antenna.

According to a third aspect, this disclosure provides an antenna array, including a plurality of antennas described above, where the plurality of antennas are arranged in an array. The plurality of antennas are arranged in the array, so that the antennas do not interfere with each other, and a receiving area of light received by the antenna can be increased. In this way, light conduction efficiency of the antenna array can be improved.

According to a fourth aspect, this disclosure provides a communication device. The communication device includes a body, the antenna described above, and a detector. The detector is electrically connected to the body, the detector is coupled to a second end face of the antenna, and the detector is configured to receive a light wave transmitted by the antenna or an antenna array, and convert the light wave into an electrical signal, to send the electrical signal to the body.

In the communication device in this disclosure, the antenna or the antenna array can receive the light wave at a large field of view, and has high light receiving efficiency, light conduction efficiency, and light concentration efficiency. A size of the antenna matches a size of a photosensitive surface of the detector, to improve coupling efficiency between the antenna and the detector. In this way, a signal-to-noise ratio of the communication device during signal reception can be improved.

### BRIEF DESCRIPTION OF DRAWINGS

To describe technical solutions in embodiments of the present disclosure or the background more clearly, the following briefly describes accompanying drawings used for describing embodiments of the present disclosure or the background.

FIG. 1 is a diagram of a structure of a communication device according to an embodiment of this disclosure;

FIG. 2 is a diagram of a structure of an antenna array according to an embodiment of this disclosure;

FIG. 3 is a diagram of a structure of another antenna array according to an embodiment of this disclosure;

FIG. 4 is a diagram of a structure of an antenna according to an embodiment of this disclosure;

FIG. 5 is a top view of FIG. 4;

FIG. 6 is a bottom view of FIG. 4;

FIG. 7 is a diagram of a structure of another antenna according to an embodiment of this disclosure;

FIG. 8 is a diagram of a structure of still another antenna according to an embodiment of this disclosure;

FIG. 9 is a top view of FIG. 8;

FIG. 10 is a diagram of a structure of still another antenna according to an embodiment of this disclosure;

FIG. 11 is a top view of FIG. 10;

FIG. 12 is an exploded view of a three-dimensional structure of still another antenna according to an embodiment of this disclosure;

FIG. 13 is an exploded view of a three-dimensional structure of still another antenna according to an embodiment of this disclosure;

FIG. 14 is a diagram of a three-dimensional structure of an antenna according to another embodiment of this disclosure;

FIG. 15 is a diagram of a three-dimensional structure of another antenna according to another embodiment of this disclosure; and

FIG. 16 is a diagram of a three-dimensional structure of another antenna according to another embodiment of this disclosure.

### REFERENCE NUMERALS

10—Communication device; 11—Body; 12—Detector; 13—Housing; 14—Processor; 100—Antenna; 110—Base body; 111—First end face; 112—Second end face; 113—Cladding layer; 113a—hole; 114—Fiber core; 115—Busbar; 115a—First arc; 115b—Second arc; 120—Fluorescent body; 131—Light concentration lens; 132—Microstructure lens array; 132a—Microstructure lens; 133—Lens having a microstructure array; 133a—Microstructure; 134—Anti-reflective film; 140—Supersurface layer; 141—Metal particle; and 200—Antenna array.

### DESCRIPTION OF EMBODIMENTS

The following describes embodiments of the present disclosure with reference to the accompanying drawings in embodiments of the present disclosure.

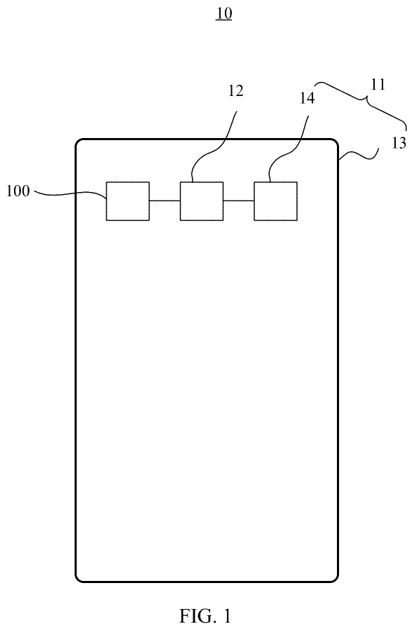

FIG. 1 is a diagram of a structure of a communication device 10 according to an embodiment of this disclosure. The communication device 10 includes a body 11, a detector 12, and an antenna 100. The body 11 is electrically connected to the detector 12, and the detector 12 is coupled to the antenna 100. The antenna 100 is configured to receive a light wave and transmit the light wave to the detector 12. The detector 12 senses the light wave transmitted by the antenna 100, converts the light wave into an electrical signal, and then transmits the electrical signal to the body 11.

The body 11 includes a housing 13 and a processor 14. The housing 13 is configured to fasten the detector 12 and the antenna 100. The processor 14 is fastened to the housing 13 and is electrically connected to the detector 12. After obtaining the electrical signal transmitted by the detector 12, the processor 14 can obtain information data carried in the light wave received by the antenna 100.

The communication device 10 may be a receiver, a mobile phone, a computer, a router, a base station, a large-screen television, customer premises equipment (Customer Premises Equipment, CPE), or any other communication device 10 having an antenna 100. A type of the communication device 10 is not specifically limited herein.

Optionally, the communication device 10 may alternatively be a terminal device or an access network device. The terminal device may be deployed on land, including an indoor or outdoor terminal device, a handheld terminal device, a wearable terminal device, or a vehicle-mounted terminal device; or may be deployed on a water surface (for example, on a ship); or may be deployed in air (for example, on an airplane, a balloon, or a satellite). The terminal device may be a mobile phone (mobile phone), a tablet computer (Pad), a computer having a wireless transceiver function, a virtual reality (virtual reality, VR) terminal, an augmented reality (augmented reality, AR) terminal, a wireless terminal in industrial control (industrial control), a vehicle-mounted terminal, a wireless terminal in a self-driving vehicle, a wireless terminal in telemedicine (remote medical), a wireless terminal in a smart grid (smart grid), a wireless terminal in transportation safety (transportation safety), a wireless terminal in a smart city (smart city), a wireless terminal in a smart home (smart home), a wearable terminal, or the like. An application scenario is not limited in embodiments of this disclosure. The terminal device may sometimes also be referred to as a terminal, user equipment (user equipment, UE), an access terminal, a vehicle-mounted terminal, an industrial control terminal, a mobile station, a remote station, a remote terminal, a mobile device, a wireless communication device, or the like. The terminal device may be fixed or mobile. The access network device is a radio access network (radio access network, RAN) node that connects the terminal device to a wireless network. The RAN node includes but is not limited to: a gNB, a transmission reception point (transmission reception point, TRP), an evolved NodeB (evolved NodeB, eNB), a radio network controller (radio network controller, RNC), a NodeB (NodeB, NB), a base station controller (base station controller, BSC), a base transceiver station (base transceiver station, BTS), a home base station (for example, a home evolved NodeB, or a home NodeB, HNB), a baseband unit (baseband unit, BBU), a wireless fidelity (wireless fidelity, Wi-Fi) access point (access point, AP), or an integrated access and backhaul (integrated access and backhaul, IAB).

The detector 12 may be a photosensitive diode, and the photosensitive diode has a photosensitive surface coupled to the antenna 100. Specifically, the photosensitive surface of the photosensitive diode is attached to an end of the antenna 100 in which the light wave is output.

An embodiment of this disclosure discloses an antenna array 200. The antenna array 200 includes a plurality of antennas 100, and the plurality of antennas 100 are arranged in an array, so that the antennas 100 do not interfere with each other, and a receiving area of light received by the antenna array 200 can be increased. In this way, light conduction efficiency of the antenna array 200 can be improved.

The antenna array 200 may be used in a receiver, a mobile phone, a computer, a router, a base station, a large-screen television, customer premises equipment (Customer Premises Equipment, CPE), or any other communication device 10 having an antenna 100.

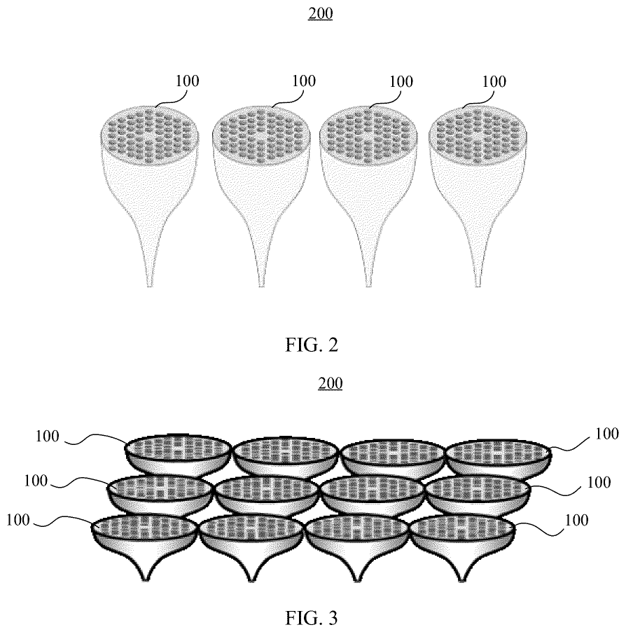

Refer to FIG. 2. A plurality of antennas 100 may be arranged in a 1×n (n>1) linear array to form an antenna array 200. The antenna array 200 in a linear array arrangement form can be used in a small-sized and portable communication device 10, for example, a mobile phone. The antenna array 200 in the linear array arrangement form is easier to avoid another electronic element, to avoid interference from the another electronic element.

Refer to FIG. 3. A plurality of antennas 100 may be in an m×n (m>1 and n>1) planar array arrangement form to form an antenna array 200. The antennas 100 in the planar array arrangement form are arranged in a more centralized manner. This facilitates integration of the antenna array 200. The antenna array 200 in the planar array arrangement form can be used in a large-sized communication device 10, for example, a base station.

A shape of the antenna array and that is presented in two-dimensional space may alternatively be a square grid, a circular grid, a regular hexagonal grid, or the like. The shape that is of the antenna array and that is presented in the two-dimensional space is not specifically limited in this disclosure.

There may be a plurality of structures of the antennas 100. A same antenna array 200 may be formed by combining a plurality of antennas 100 of a same structure. Alternatively, a same antenna array 200 may have antennas 100 of different structures.

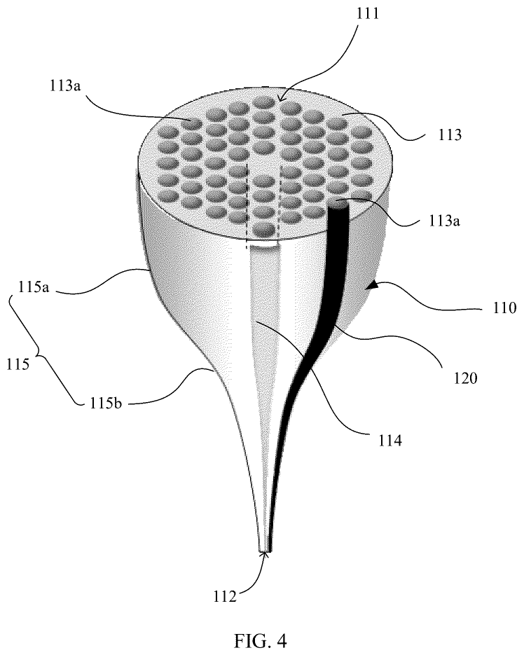

A possible structure of the antenna 100 is described below with reference to FIG. 4 to FIG. 13.

### Embodiment 1

FIG. 4 is a diagram of a structure of an antenna 100 according to an embodiment of this disclosure. The antenna 100 includes a base body 110 and a plurality of fluorescent bodies 120. A material of the base body 110 may be high-purity silicon dioxide, and the base body 110 is transparent and can transmit an optical signal. The base body 110 includes a first end face 111 and a second end face 112 that are oppositely provided in an axial direction of the base body 110. The base body 110 gradually shrinks from the first end face 111 toward the second end face 112, and a size of the first end face 111 is greater than a size of the second end face 112. It may be understood that, an axial cross section of the base body 110 gradually decreases from the first end face 111 toward a direction in which the second end face 112 is located.

A plurality of holes 113a arranged in an array are provided in the base body 110. The plurality of holes 113a surround an outer periphery of a first area in the base body 110, the first area surrounded by the plurality of holes 113a in the base body 110 is a fiber core 114, and an area at an outer periphery of the fiber core 114 in the base body 110 is a cladding layer 113. It should be noted that the fiber core 114 in this disclosure is not a hollow structure that is hollow in the middle.

The fiber core 114 gradually shrinks from the first end face 111 toward the direction in which the second end face 112 is located. It may be understood that, a size of the fiber core 114 on the first end face 111 is greater than a size of the fiber core 114 on the second end face 112.

Each of the holes 113a penetrates the first end face 111 and the second end face 112 that are of the base body 110, and each of the holes 113a gradually shrinks from the first end face 111 toward the direction in which the second end face 112 is located. It may be understood that, a size of each of the holes 113a on the first end face 111 is greater than a size of each of the holes 113a on the second end face 112, and each of the holes 113a gradually approaches the fiber core 114 from the first end face 111 toward the direction in which the second end face 112 is located.

Sizes of the holes 113a may or may not be equal. The holes 113a are distributed at the outer periphery of the fiber core 114. Optionally, the holes 113a are evenly distributed at the outer periphery of the fiber core 114.

The fluorescent body 120 includes a fluorescent material and a transparent polymer, where a mass fraction of the fluorescent material in the fluorescent body 120 ranges from 0.01 wt % to 0.5 wt %. The mass fraction of the fluorescent material in the fluorescent body 120 may be 0.01 wt %; or the mass fraction of the fluorescent material in the fluorescent body 120 may be 0.5 wt %. Specifically, the mass fraction of the fluorescent material in the fluorescent body 120 may range from 0.05 wt % to 0.1 wt %. The mass fraction of the fluorescent material in the fluorescent body 120 may be 0.05 wt %; or the mass fraction of the fluorescent material in the fluorescent body 120 may be 0.1 wt %.

In this embodiment of the disclosure, the fluorescent material and the transparent polymer are filled in at least a part of the plurality of holes 113a to form the fluorescent body 120. The fluorescent material may be one of a luminescent quantum dot, an organic luminescent material, or a rare earth material. The organic luminescent material may be specifically fluorescein isothiocyanate (fluorescein isothiocyanate, FITC), carboxyfluorescein (carboxyfluorescein, FAM), 7-Aminocoumarin (7-Amino-4-trifluoromethylcoumarin and 7-Amino-4-methylcoumarin, where 7-Amino-4-trifluoromethylcoumarin is abbreviated as AFC, and 7-Amino-4-methylcoumarin is abbreviated as AMC), rhodamine X (Rhodamine X, Rox), sulforhodamine 101 (Sulforhodamine 101), 5-carboxytetramethylrhodamine (5-Carboxytetramethylrhodamine, 5-TAMRA), EDANS (5-((2-Aminoethyl)amino)naphthalene-1-sulfonic acid), sulfonyl rhodamine 101 (Texas Red), rhodamine 6G (Rhodamine 6G), rhodamine B (Rhodamine B), rhodamine 123 (Rhodamine 123), rhodamine WT (Rhodamine WT), or the like. A material of the polymer may be any one of dodecyl methacrylate (dodecyl methacrylate), polymethyl methacrylate (polymethyl methacrylate), polyethylene (polyethylene), polycarbonate (Polycarbonate), polyvinyl chloride (Polyvinyl chloride), polystyrene (Expandable Polystyrene), epoxy resin (Phenolic epoxy resin), or acrylic acid resin (Acrylic acid Polymers).

In this embodiment of the disclosure, the first end face 111 of the base body 110 is for receiving incident light, and the second end face 112 of the base body 110 is for coupling to a detector 12 and transmitting, to the detector 12, a light wave entering the base body 110. The incident light entering the base body 110 may be transmitted through the fiber core 114 or the cladding layer 113, and transmitted to the detector 12 through the second end face 112. The fluorescent body 120 can capture the incident light, and convert the incident light into light whose wavelength is greater than that of the incident light in the case of Stokes shift. The light emitted by the fluorescent body 120 can propagate in the base body 110, and then be transmitted to the detector 12 through the second end face 112 of the base body 110. It should be noted that, the fiber core 114 is located in a central area of the base body 110, and most of light in the base body 110 propagates in the fiber core 114 and then is transmitted to the detector 12.

In this embodiment of the disclosure, a refractive index of the fluorescent body 120 is less than a refractive index of the base body 110. In addition, the fluorescent body 120 is located in the hole 113a on the cladding layer 113, and it can be learned that a refractive index of the cladding layer 113 is less than a refractive index of the fiber core 114. Therefore, when the light enters the fiber core 114, a probability that the light escapes from the fiber core 114 can be reduced, to increase a reflection probability of the light during propagation in the fiber core 114. In this way, a light concentration capability and light conduction efficiency of the antenna 100 are improved.

In this embodiment of the disclosure, the axial cross section of the base body 110 is one of a circle, an ellipse, or a polygon. For example, the axial cross section of the base body 110 may be a triangle, a quadrangle, a pentagon, or a hexagon. It should be noted that, the axial cross section of the base body 110 is a cross section parallel to the first end face 111 or the second end face 112. The axial cross section of the base body 110 may be the first end face 111 or the second end face 112; or the axial cross section of the base body 110 may be a cross section between the first end face 111 and the second end face 112.

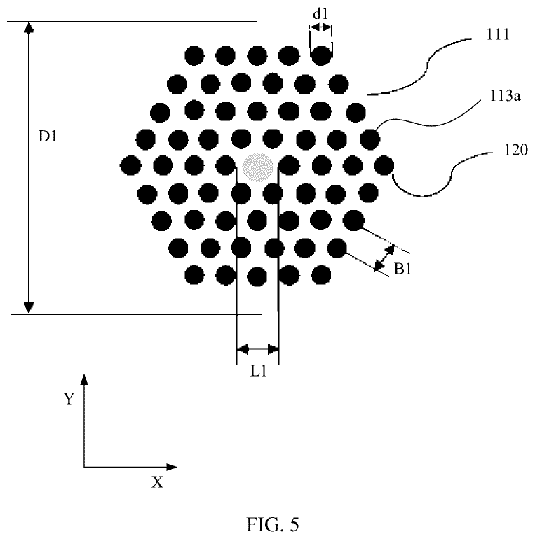

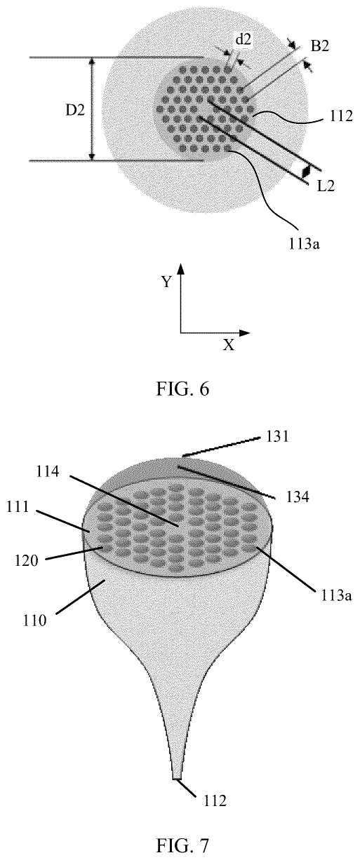

Refer to FIG. 5 and FIG. 6. For example, the axial cross section of the base body 110 is the circle. The second end face 112 of the base body 110 is coupled to the detector 12, the size of the second end face 112 of the base body 110 matches a size of a photosensitive surface of the detector 12, and a diameter D2 of the second end face 112 ranges from 20 μm to 1 mm. It should be noted that, the diameter of the second end face 112 may be 20 μm; or the diameter of the second end face 112 may be 1 mm. In this embodiment of the disclosure, when a specific size of the second end face 112 is set, a specific error is allowed for the specific size of the second end face 112. Optionally, the allowed error may be ±10%. For example, if the diameter of the second end face 112 is set to 20 μm, and the error allowed for the diameter of the second end face 112 is ±2um, an actual size of the second end face 112 may range from 18 μm to 22 μm. If the diameter of the second end face is set to 1 mm, and the error allowed for the diameter of the second end face is ±100 μm, an actual size of the second end face may range from 900 μm to 1.1 mm.

A diameter DI of the first end face 111 of the base body 110 ranges from 1 mm to 200 mm. It should be noted that, the diameter of the first end face 111 may be 1 mm; or the diameter of the first end face 111 may be 200 mm. In this embodiment of the disclosure, when a specific size of the first end face 111 is set, a specific error is allowed for the specific size of the first end face 111. Optionally, the allowed error may be ±10%. For example, if the diameter of the first end face 111 is set to 1 mm, and the error allowed for the diameter of the first end face 111 is ±100 μm, an actual size of the first end face 111 may range from 0.9 mm to 1.1 mm. If the diameter of the first end face 111 is set to 200 mm, and the error allowed for the diameter of the first end face 111 is ±20 mm, an actual size of the first end face 111 may range from 180 mm to 220 mm.

An axial cross section of the fiber core 114 may be a circle, an ellipse, a polygon, or another irregular pattern. A shape of the axial cross section of the fiber core 114 is not specifically limited in this disclosure. In this disclosure, for example, the axial cross section of the fiber core 114 is surrounded by the plurality of holes 113a to form a circle. A diameter L2 of the fiber core 114 on the second end face 112 ranges from 5 μm to 60 μm. It should be noted that, the diameter L2 of the fiber core 114 on the second end face 112 may be 5 μm; or the diameter L2 of the fiber core 114 on the second end face 112 may be 60 μm. In this embodiment of the disclosure, when a specific size of the fiber core 114 on the second end face 112 is set, a specific error is allowed for the diameter L2 of the fiber core 114 on the second end face 112. Optionally, the allowed error may be ±10%. For example, if the diameter of the fiber core 114 on the second end face 112 is set to 5 μm, and the error allowed for the diameter of the fiber core 114 on the second end face 112 is ±0.5 μm, an actual diameter of the fiber core 114 on the second end face 112 may range from 4.5 μm to 5.5 μm. If the diameter of the fiber core 114 on the second end face 112 is set to 60 μm, and the error allowed for the diameter of the fiber core 114 on the second end face 112 is ±6 μm, an actual diameter of the fiber core 114 on the second end face 112 may range from 54 μm to 66 μm.

A diameter L1 of the fiber core 114 on the first end face 111 ranges from 100 μm to 800 μm. The diameter L1 of the fiber core 114 on the first end face 111 may be 100 μm; or the diameter L1 of the fiber core 114 on the first end face 111 may be 800 μm. In this embodiment of the disclosure, when a specific size of the fiber core 114 on the first end face 111 is set, an error is allowed for the diameter L1 of the fiber core 114 on the first end face 111. Optionally, the allowed error may be ±10%. For example, if the diameter of the fiber core 114 on the first end face 111 is set to 100 μm, and the error allowed for the diameter of the fiber core 114 on the first end face 111 is ±10 μm, an actual diameter of the fiber core 114 on the first end face 111 may range from 90 μm to 110 μm. If the diameter of the fiber core 114 on the first end face 111 is set to 800 μm, and the error allowed for the diameter of the fiber core 114 on the first end face 111 is ±80 μm, an actual diameter of the fiber core 114 on the first end face 111 may range from 720 μm to 880 μm.

A diameter d2 of each of the holes 113a on the second end face 112 ranges from 0.5 um to 60 μm. The diameter d2 of each of the holes on the second end face 112 may be 0.5 μm; or the diameter d2 of each of the holes on the second end face 112 may be 60 μm. In this embodiment of the disclosure, when the diameter d2 of the hole on the second end face 112 is set, a specific error is allowed for the diameter d2 of the hole on the second end face 112. Optionally, the allowed error may be ±10%. For example, if the diameter d2 of the hole on the second end face 112 is set to 0.5 μm, and the error allowed for the diameter d2 of the hole on the second end face 112 is ±0.05 μm, an actual diameter d2 of the hole on the second end face 112 may range from 0.45 μm to 0.55 μm. If the diameter d2 of the hole on the second end face 112 is set to 60 μm, and the error allowed for the diameter d2 of the hole on the second end face 112 is ±6 μm, an actual diameter d2 of the hole on the second end face 112 may range from 54 μm to 66 μm.

A diameter d1 of each of the holes 113a on the first end face 111 ranges from 50 μm to 300 μm. The diameter d1 of each of the holes 113a on the first end face 111 may be 50 μm; or the diameter d1 of each of the holes 113a on the first end face 111 may be 300 μm. In this embodiment of the disclosure, when the diameter d1 of each of the holes 113a on the first end face 111 is set, a specific error is allowed to exist. Optionally, the allowed error may be ±10%. For example, if the diameter d1 of the hole 113a on the first end face 111 is set to 50 μm, and the allowed error is ±5 μm, an actual diameter d1 of the hole 113a on the first end face 111 may range from 45 μm to 55 μm. If the diameter d1 of the hole 113a on the first end face 111 is set to 300 μm, and the allowed error is ±30 μm, an actual diameter d1 of the hole 113a on the first end face 111 may range from 270 μm to 330 μm.

The diameter of the first end face 111 is far greater than the diameter of the second end face 112. In this disclosure, the diameter of the first end face 111 is increased, so that an area of a light wave received by the antenna 100 is increased, to increase a quantity of light waves received by the antenna 100. In this way, performance of transmitting the light wave by the antenna 100 is further improved. The fiber core 114 and each of the holes 113a shrink from the first end face 111 toward the second end face 112, so that the antenna 100 concentrates light. In this way, a probability that the light escapes from the base body 110 can be reduced, and efficiency of transmitting the light wave by the antenna 100 can be improved. The fiber core 114 gradually shrinks from the first end face 111 toward the direction in which the second end face 112 is located, so that light can be concentrated, and the reflection probability of the light in the fiber core 114 is increased. In this way, efficiency of transmitting the light wave by the antenna 100 can be improved.

In this embodiment of the disclosure, a busbar 115 of the base body 110 may include a first arc 115a and a second arc 115b. A first end of the first arc 115a extends to the first end face 111, a second end of the first arc 115a is connected to a first end of the second arc 115b, and a second end of the second arc 115b extends to the second end face 112. A curvature of the first arc 115a ranges from 5 mm to 200 mm, and a curvature of the second arc 115b ranges from 5 mm to 200 mm. The curvature of the second arc 115b may or may not be equal to the curvature of the first arc 115a.

It should be noted that, the curvature of the first arc 115a may be 5 mm; or the curvature of the first arc 115a may be 200 mm. In this embodiment of the disclosure, when the curvature of the first arc 115a is set, a specific error is allowed for the curvature of the first arc 115a. Optionally, the allowed error may be ±10%. For example, if the curvature of the first arc 115a is set to 5 mm, and the allowed error is ±0.5 mm, an actual curvature of the first arc 115a may range from 4.5 mm to 5.5 mm. If the curvature of the first arc 115a is set to 200 mm, and the allowed error is ±20 mm, an actual curvature of the first arc 115a may range from 180 mm to 220 mm.

The curvature of the second arc 115b may be 5 mm; or the curvature of the second arc 115b may be 200 mm. In this embodiment of the disclosure, when the curvature of the second arc 115b is set, a specific error is allowed for the curvature of the second arc 115b. Optionally, the allowed error may be ±10%. For example, if the curvature of the second arc 115b is set to 5 mm, and the allowed error is ±0.5 mm, an actual curvature of the second arc 115b may range from 4.5 mm to 5.5 mm. If the curvature of the second arc 115b is set to 200 mm, and the allowed error is ±20 mm, an actual curvature of the second arc 115b may range from 180 mm to 220 mm.

In this embodiment of the disclosure, the busbar 115 of the base body 110 is a geometric concept. The busbar 115 of the base body 110 may be a contour line of the base body 110, or the busbar 115 of the base body 110 may be a shortest connection line from any point on an edge of the first end face 111 to an edge of the second end face 112. The busbar 115 of the base body 110 may be a segment of arc. Alternatively, the busbar 115 of the base body 110 may include two or more segments of arc.

For example, the busbar 115 of the base body 110 includes the first arc 115a and the second arc 115b that are connected to each other. A circle center for the first arc 115a is on a first side (right side) of the busbar 115, and a circle center for the second arc 115b is on a second side (left side) of the busbar 115. The circle center for the first arc 115a and the circle center for the second arc 115b are respectively on two sides of the busbar 115 in which the first arc 115a and the second arc 115b are located, so that the base body 110 can shrink more smoothly from the first end face 111 toward the second end face 112. In this way, light conduction efficiency of the antenna 100 is improved.

In this embodiment of the disclosure, the size of the second end face 112 on the base body 110 matches the size of the photosensitive surface of the detector 12, so that a probability that the light wave in the antenna 100 escapes to the outside of the photosensitive surface of the detector 12 can be reduced, to improve transmission efficiency of transmission by the antenna 100. The plurality of holes 113a are provided on the cladding layer 113 in the base body 110. The refractive index of the cladding layer 113 can be adjusted and controlled by controlling a quantity of the holes 113a, diameters of the holes 113a, or spacings between adjacent holes 113a. The fluorescent body 120 is provided in the hole 113a. The fluorescent body 120 can capture the incident light, and convert the incident light into the light wave whose wavelength is greater than that of the incident light in the case of Stokes shift, so that the antenna can receive the light without following conservation of optical etendue. The fluorescent body 120 is located at the outer periphery of the fiber core 114, and can emit the light to the fiber core 114, to increase an optical field of view of the antenna 100. The axial cross section of the fiber core 114 gradually decreases from the first end face 111 toward the direction in which the second end face 112 is located, to achieve light concentration effects, so that total reflection can occur on the light entering the fiber core 114. In this way, the probability that the light entering the fiber core 114 escapes from the fiber core 114 is reduced, to improve transmission efficiency of the antenna 100.

In this embodiment of the disclosure, refer to FIG. 5. In each axial cross section of the base body 110, in an example of the first end face 111, spacings between adjacent holes 113a at the outer periphery of the fiber core 114 may or may not be equal. The overall refractive index of the cladding layer 113 can be adjusted by controlling a distance between the adjacent holes 113a at the outer periphery of the fiber core 114 or by controlling a ratio of a spacing between adjacent holes 113a that are in a Y-axis direction and that are in the plurality of holes 113a at the outer periphery of the fiber core 114 to a spacing between adjacent holes 113a that are in an X-axis direction and that are in the plurality of holes 113a at the outer periphery of the fiber core 114. Specifically, the spacing between the adjacent holes 113a in the Y-axis direction is equal to the spacing between the adjacent holes 113a in the X-axis direction. Alternatively, the ratio of the spacing between the adjacent holes 113a in the Y-axis direction to the spacing between the adjacent holes 113a in the X-axis direction is \sqrt{3}/2. Alternatively, the ratio of the spacing between the adjacent holes 113a in the Y-axis direction to the spacing between the adjacent holes 113a in the X-axis direction may be another value. This is not specifically limited in this disclosure.

It should be noted that, a spacing B1 between the adjacent holes 113a is a distance between two circle centers of two adjacent holes 113a. The spacing B2 between the adjacent holes 113a in the Y-axis direction is a distance, in the Y-axis direction, between two circle centers of two adjacent holes 113a in the Y-axis direction. The spacing between the adjacent holes 113a in the X-axis direction is a distance, in the X-axis direction, between two circle centers of two adjacent holes 113a in a Y direction.

In this embodiment of the disclosure, the diameter DI of the first end face 111 of the base body 110 is 15 mm, the diameter D2 of the second end face 112 is 0.5 mm, and the plurality of holes 113a in the base body 110 are arranged in the array. The array formed by the plurality of holes 113a is substantially in a regular hexagonal shape. The diameter d1 of each of the holes 113a on the first end face 111 is 0.2 μm, and the diameter d2 of each of the holes 113a on the second end face 112 is 0.02 μm. The diameter L1 of the fiber core 114 on the first end face 111 is 0.4 mm, and the diameter L2 of the fiber core 114 on the second end face 112 is 0.04 mm. The spacing B1 between the adjacent holes 113a that are on the first end face 111 and that are at the outer periphery of the fiber core 114 is 1 mm, and a spacing B2 between the adjacent holes 113a that are on the second end face 112 and that are at the outer periphery of the fiber core 114 is 0.04 mm.

In this embodiment of the disclosure, to increase the area of the light wave received by the antenna 100, specifically, an area of the first end face 111 of the base body 110 is increased to increase the area of the light wave received by the antenna 100. Because an area of the second end face 112 of the base body 110 needs to match bandwidth of the photosensitive surface of the detector 12, when the size of the second end face 112 of the base body 110 remains unchanged, a larger size of the first end face 111 of the base body 110 indicates a larger ratio of the size of the first end face 111 of the base body 110 to the size of the second end face 112 of the base body 110. To increase the reflection probability of the light during transmission in the fiber core 114 and a reflection probability of the light during transmission in the cladding layer 113, an axial dimension (a distance from the first end face 111 to the second end face 112) of the base body 110 needs to be considered. A longer axial dimension of the base body 110 indicates a larger incident angle of the light during transmission of the light entering the base body 110 from the first end face 111 to the second end face 112, and indicates that total reflection more easily occurs on the light entering the base body 110 during transmission.

In a possible implementation, the antenna 100 further includes a light concentration member. The light concentration member is connected to the first end face 111 of the base body 110. In an axial direction of the base body 110, a projection of the light concentration member covers the fiber core 114 and the holes 113a.

Refer to FIG. 7 to FIG. 11. The light concentration member is configured to receive light and/or concentrate the light. The light concentration member may increase a field of view of the antenna 100 for receiving a light ray. A material of the light concentration member may be one of BK7 glass or K9 glass.

The light concentration member may be doped with a fluorescent material, or may not be doped with a fluorescent material.

If the fluorescent material is doped in the light concentration member, after capturing incident light, the light concentration member can emit a light wave whose wavelength is greater than that of the incident light toward the first end face 111.

Refer to FIG. 7. In FIG. 7, components the same as those presented in FIG. 4 are not described herein again. A specific structure of the light concentration member included in the antenna 100 in FIG. 7 may be a light concentration lens 131. The light concentration lens 131 is connected to the first end face 111, and the light concentration lens 131 protrudes from the first end face 111 toward a direction away from the second end face 112. The light concentration lens 131 is provided on the antenna 100, so that a receiving area of the light wave received by the antenna 100 can be greatly increased, and the field of view of the antenna 100 for receiving the light ray can be increased. An anti-reflective film 134 is provided on the light concentration lens 131. The anti-reflective film 134 helps increase a probability that the light wave enters the antenna 100, and the anti-reflective film 134 can further reduce a probability that the light in the antenna 100 escapes from the light concentration lens 131.

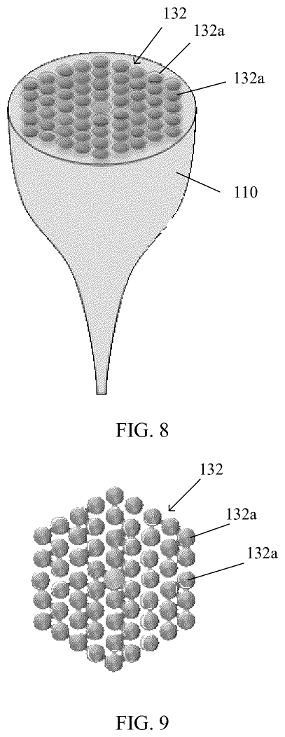

Refer to FIG. 8 and FIG. 9. In FIG. 8, components the same as those presented in FIG. 4 are not described herein again. The light concentration member included in the antenna 100 in FIG. 8 may be a microstructure lens array 132. Specifically, the microstructure lens array 132 includes a plurality of microstructure lenses 132a arranged in an array. Each of the microstructure lenses 132a may correspond to one hole 113a or one fiber core 114. Alternatively, the fiber core 114 and one or more holes 113a or the plurality of holes 113a correspond to one microstructure lens 132a. The microstructure lens array 132 covers the first end face 111, and the microstructure lens array 132 can converge the light wave, to increase the field of view of the antenna 100 for receiving the light ray. In some embodiments, an anti-reflective film may be provided on the microstructure lens array 132. The anti-reflective film helps increase a probability that the light wave enters the antenna 100, and the anti-reflective film can further reduce a probability that the light in the antenna 100 escapes from the microstructure lens array 132.

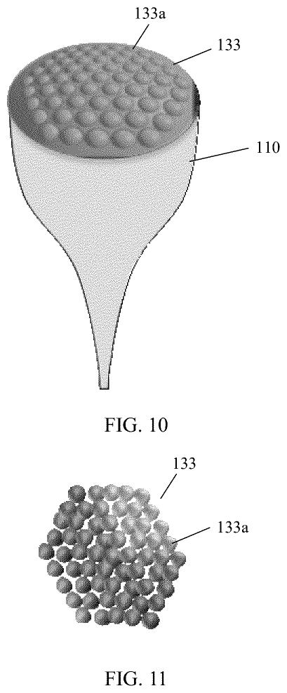

Refer to FIG. 10 and FIG. 11, the light concentration member may be a lens 133 having a microstructure array. The lens includes a plurality of microstructures 133a, and the plurality of microstructure are arranged in an array. The lens 133 having the microstructure array can converge the light wave, to increase the field of view of the antenna 100 for receiving the light ray. In some embodiments, an anti-reflective film may be provided on the lens 133 having the microstructure array. The anti-reflective film helps increase a probability that the light wave enters the antenna 100, and the anti-reflective film can further reduce a probability that the light in the antenna 100 escapes from the lens 133 having the microstructure array.

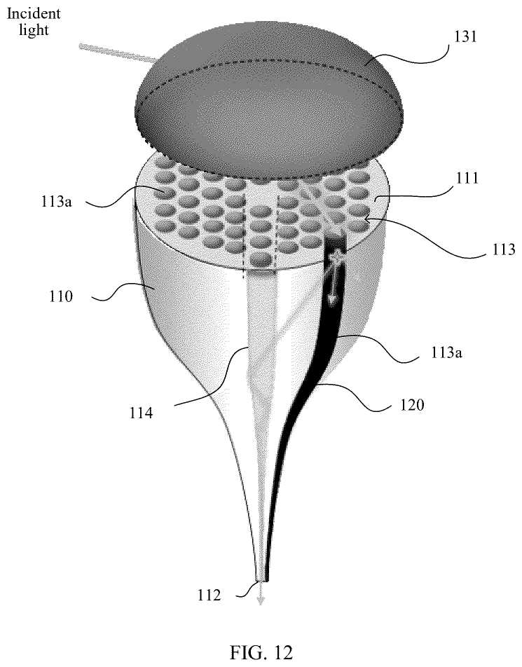

Refer to FIG. 12. For example, the light concentration member is the light concentration lens 131. When the antenna 100 transmits the light wave, the light concentration lens 131 receives the incident light, and transmits the received light to the fiber core and the fluorescent body 120 in the hole 113a. The fluorescent body 120 receives the incident light and can emit the light wave whose wavelength is greater than that of the incident light to the fiber core 114. The refractive index of the fiber core 114 is greater than the refractive index of the cladding layer, and the fiber core shrinks from the first end face 111 toward the second end face 112. Therefore, cases in which the light wave escapes from the fiber core 114 can be reduced, to improve light concentration effects of the antenna 100.

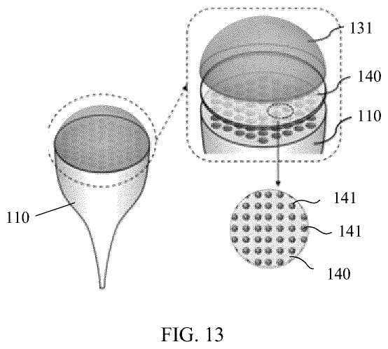

Refer to FIG. 13. A supersurface layer 140 may be further provided on the antenna 100. The supersurface layer 140 is provided between the first end face 111 and the light concentration member, and the supersurface layer 140 is a layered structure whose thickness is less than a wavelength of the light wave. The supersurface layer 140 can adjust and control a characteristic, such as a phase or a propagation direction, of the light wave. After receiving the incident light, the light concentration member emits a new light wave or transmits the received light wave to the supersurface layer 140. The supersurface layer 140 can change a transmission direction of the light wave, so that the light wave can be perpendicular to the first end face 111 and transmitted to the base body 110, to reduce an incident angle of the light wave input to the base body 110, reduce a probability that the light wave is reflected on the first end face 111, and improve efficiency of receiving the light wave by the base body 110.

A plurality of metal particles 141 are provided on the supersurface layer 140, and the metal particles 141 are arranged in an array. The array of the metal particles 141 can change the phase and polarization that are of the light wave, so that the light wave is more easily received by the antenna 100, to improve efficiency of receiving the light wave by the antenna 100. In this embodiment of the disclosure, the metal particle 141 may be silver Ag, gold Au, aluminum Al, or the like. A distance between adjacent metal particles on the supersurface layer 140 ranges from 50 nm to 500 nm, and the distance between the adjacent metal particles on the supersurface layer 140 is a distance between geometric centers of two adjacent metal particles. The distance between the adjacent metal particles on the supersurface layer 140 may be 50 nm; or the distance between the adjacent metal particles on the supersurface layer 140 may be 500 nm. It should be noted that, when the distance between the adjacent metal particles on the supersurface layer 140 is set, a specific error is allowed. Optionally, the allowed error may be ±10%. For example, if the distance between the adjacent metal particles on the supersurface layer 140 is set to 50 nm, and the allowed error is ±5 nm, an actual distance between the adjacent metal particles on the supersurface layer 140 may range from 45 nm to 55 nm. If the distance between the adjacent metal particles on the supersurface layer 140 is set to 500 nm, and the allowed error is ±50 nm, an actual distance between the adjacent metal particles on the supersurface layer 140 may range from 450 nm to 550 nm.

### Embodiment 2

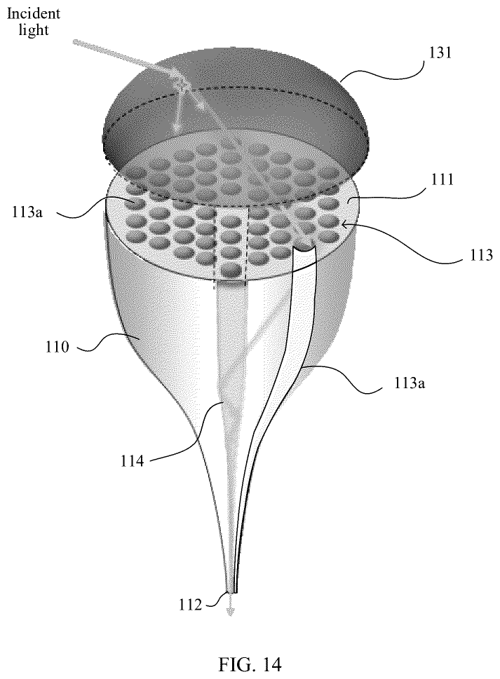

Different from the antenna 100 in Embodiment 1, an antenna 100 in this embodiment of this disclosure is not provided with a fluorescent body 120 in a hole 113a. For details, refer to FIG. 14 to FIG. 16. The antenna 100 includes a base body 110 and a light concentration member. The base body 110 includes a first end face 111 and a second end face 112 that are oppositely provided. The base body 110 shrinks from the first end face 111 toward the second end face 112. The first end face 111 is connected to the light concentration member. A supersurface layer 140 is provided between the first end face 111 and the light concentration member, and the light concentration member includes a fluorescent material. A plurality of holes 113a arranged in an array are provided in the base body 110. The plurality of holes 113a surround an outer periphery of a first area in the base body 110, the first area surrounded by the plurality of holes 113a in the base body 110 is a fiber core 114, and an area at an outer periphery of the fiber core 114 in the base body 110 is a cladding layer 113.

Each of the holes 113a penetrates the first end face 111 and the second end face 112 that are of the base body 110, and each of the holes 113a gradually shrinks from the first end face 111 toward a direction in which the second end face 112 is located. It may be understood that, a size of each of the holes 113a on the first end face 111 is greater than a size of each of the holes 113a on the second end face 112, and each of the holes 113a gradually approaches the fiber core 114 from the first end face 111 toward the direction in which the second end face 112 is located.

A main material of the light concentration member may be one of BK7 glass or K9 glass. The fluorescent material included in the light concentration member may be one of a luminescent quantum dot, an organic luminescent material, or a rare earth material. The organic luminescent material may be specifically fluorescein isothiocyanate (fluorescein isothiocyanate, FITC), carboxyfluorescein (carboxyfluorescein, FAM), 7-Aminocoumarin (7-Amino-4-trifluoromethylcoumarin and 7-Amino-4-methylcoumarin, where 7-Amino-4-trifluoromethylcoumarin is abbreviated as AFC, and 7-Amino-4-methylcoumarin is abbreviated as AMC), rhodamine X (Rhodamine X, Rox), sulforhodamine 101 (Sulforhodamine 101), 5-carboxytetramethylrhodamine (5-Carboxytetramethylrhodamine, 5-TAMRA), EDANS (5-((2-Aminoethyl)amino)naphthalene-1-sulfonic acid), sulfonyl rhodamine 101 (Texas Red), rhodamine 6G (Rhodamine 6G), rhodamine B (Rhodamine B), rhodamine 123 (Rhodamine 123), rhodamine WT (Rhodamine WT), or the like. A material of a polymer may be any one of dodecyl methacrylate (dodecyl methacrylate), polymethyl methacrylate (polymethyl methacrylate), polyethylene (polyethylene), polycarbonate (Polycarbonate), polyvinyl chloride (Polyvinyl chloride), polystyrene (Expandable Polystyrene), epoxy resin (Phenolic epoxy resin), or acrylic acid resin (Acrylic acid Polymers).

Refer to FIG. 14. The light concentration member may be a light concentration lens 131.

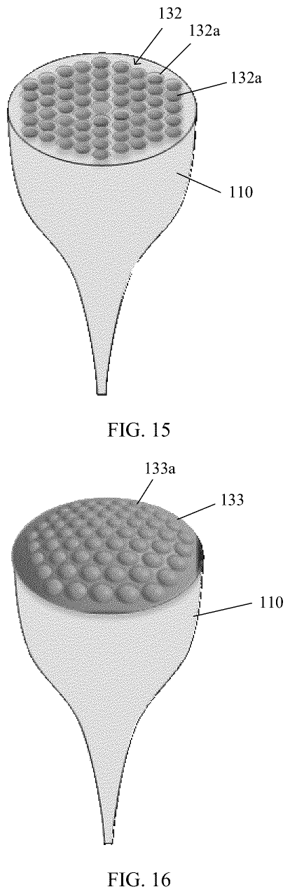

Refer to FIG. 15. Different from the light concentration member in the antenna 100 in FIG. 14, the light concentration member is a microstructure lens array 132.

Refer to FIG. 16. Different from the light concentration member in the antenna 100 in FIG. 14, the light concentration member is a lens 133 having a microstructure array.

Refer to FIG. 14 to FIG. 16. When the antenna 100 transmits a light wave, the light concentration member receives incident light, and the fluorescent material in the light concentration member can capture the incident light and emit a light wave whose wavelength is greater than that of the incident light. The light wave emitted by the light concentration member is transmitted to the base body 110. The light wave may directly enter the fiber core 114, or may enter the hole 113a on the cladding layer, and the light wave entering the hole may enter the fiber core 114. A refractive index of the fiber core 114 is greater than a refractive index of the cladding layer 113, and the fiber core 114 shrinks from the first end face 111 toward the second end face 112. Therefore, cases in which the light wave escapes from the fiber core 114 can be reduced, to improve light concentration effects of the antenna 100.

It should be noted that, all directional indications (for example, up, down, left, right, front, and back) in embodiments of this disclosure are merely used for explaining a relative positional relationship, a motion situation, and the like between components in a specific posture (as shown in the figure). If the specific posture changes, the directional indication also correspondingly changes.

In addition, descriptions such as “first” and “second” in this disclosure are merely used for description purposes, and cannot be understood as indicating or implying relative importance or implicitly indicating a quantity of indicated technical features. Therefore, features limited by “first” and “second” may explicitly or implicitly include at least one of the features. In description of this disclosure, “a plurality of” means “at least two”, such as “two” or “three”, unless otherwise clearly and specifically limited.

In this disclosure, unless otherwise clearly stated and limited, terms such as “connection” and “fixed” should be understood in a broad sense. For example, “fixed” may mean a fixed connection, or may mean a detachable connection, or an integral connection; may mean a mechanical connection, or may mean an electrical connection; or may mean a direct connection, or may mean an indirect connection via an intermediate medium, or may mean an internal connection between two elements or an interaction relationship between two elements, unless otherwise clearly stated. A person of ordinary skill in the art may understand specific meanings of the foregoing terms in this disclosure based on a specific case.

In addition, the technical solutions in embodiments of this disclosure may be combined with each other, but need to be implemented by a person of ordinary skill in the art. When combinations of the technical solutions conflict with each other or cannot be implemented, it should be considered that the combination of the technical solutions does not exist, and does not fall within the protection scope claimed in this disclosure.

The foregoing descriptions are merely specific implementations of this disclosure, but the protection scope of this disclosure is not limited thereto. Any variation or replacement readily figured out by a person skilled in the art within the technical scope disclosed in this disclosure shall fall within the protection scope of this disclosure. Therefore, the protection scope of this disclosure shall be subject to the protection scope of the claims.

1. An antenna, comprising:
a base body, wherein the base body comprises a first end face and a second end face that are oppositely disposed, and the base body shrinks from the first end face toward the second end face; and a plurality of holes that penetrate the first end face and the second end face are provided in the base body, the plurality of holes surround an outer periphery of a first area in the base body, and both the first area surrounded by the plurality of holes in the base body and each of the holes shrink from the first end face toward the second end face; and
a fluorescent body, wherein the fluorescent body is provided in at least a few of the plurality of holes.

2. The antenna according to claim 1, wherein a refractive index of the fluorescent body is less than a refractive index of the base body.

3. The antenna according to claim 1, wherein an axial cross section of the base body is one of a circle, an ellipse, or a polygon.

4. The antenna according to claim 3, wherein a busbar of the base body comprises a first arc and a second arc, a first end of the first arc extends to the first end face, a second end of the first arc is connected to a first end of the second arc, and a second end of the second arc extends to the second end face.

5. The antenna according to claim 4, wherein a curvature of the first arc ranges from 5 mm to 200 mm, and a curvature of the second arc ranges from 5 mm to 200 mm.

6. The antenna according to claim 4, wherein a circle center for the first arc and a circle center for the second arc are respectively on two sides of the busbar.

7. The antenna according to claim 1, wherein a diameter of the first end face ranges from 1mm to 200 mm, and a diameter of the second end face ranges from 20 μm to 1 mm.

8. The antenna according to claim 7, wherein an axial cross section of the first area surrounded by the plurality of holes in the base body is a circle, a diameter of the first area that is on the first end face and that is surrounded by the plurality of holes in the base body ranges from 100 μm to 800 μm, and a diameter of the first area that is on the second end face and that is surrounded by the plurality of holes in the base body ranges from 5 μm to 60 μm.

9. The antenna according to claim 8, wherein the plurality of holes are arranged in an array, a diameter of each of the holes on the first end face ranges from 50 μm to 300 μm, and a diameter of each of the holes on the second end face ranges from 0.5 μm to 60 μm.

10. The antenna according to claim 1, wherein the antenna further comprises a light concentration member connected to the first end face, and a second area projected by the light concentration member onto the first end face covers the plurality of holes and the first area surrounded by the plurality of holes in the base body.

11. The antenna according to claim 10, wherein the light concentration member is one of a light concentration lens, a microstructure lens array, or a lens having a microstructure array.

12. The antenna according to claim 10, wherein the light concentration member comprises a fluorescent material.

13. The antenna according to claim 10, wherein an anti-reflective film is disposed on a surface of the light concentration member.

14. The antenna according to claim 10, wherein the antenna further comprises a supersurface layer, and the supersurface layer is provided between the light concentration member and the first end face.

15. The antenna according to claim 14, wherein a plurality of metal particles arranged in an array are provided on the supersurface layer, and a distance between adjacent metal particles ranges from 50 nm to 500 nm.

16. An antenna, comprising:
a base body, wherein the base body comprises a first end face and a second end face that are oppositely provided, and the base body shrinks from the first end face toward the second end face; and a plurality of holes that penetrate the first end face and the second end face are provided in the base body, the plurality of holes surround an outer periphery of a first area in the base body, and both the first area surrounded by the plurality of holes in the base body and each of the holes shrink from the first end face toward the second end face; and
a light concentration member, wherein the light concentration member is connected to the first end face, a second area projected by the light concentration member onto the first end face covers the plurality of holes and the first area surrounded by the plurality of holes in the base body, and the light concentration member comprises a fluorescent material.

17. The antenna according to claim 16, wherein a refractive index of the fluorescent body is less than a refractive index of the base body.

18. The antenna according to claim 16, wherein an axial cross section of the base body is one of a circle, an ellipse, or a polygon.

19. The antenna according to claim 18, wherein a busbar of the base body comprises a first arc and a second arc, a first end of the first arc extends to the first end face, a second end of the first arc is connected to a first end of the second arc, and a second end of the second arc extends to the second end face.

20. The antenna according to claim 19, wherein a curvature of the first arc ranges from 5 mm to 200 mm, and a curvature of the second arc ranges from 5 mm to 200 mm; and/or, wherein a circle center for the first arc and a circle center for the second arc are respectively on two sides of the busbar; and/or, wherein a diameter of the first end face ranges from 1 mm to 200 mm, and a diameter of the second end face ranges from 20 μm to 1 mm; and/or
wherein an axial cross section of the first area surrounded by the plurality of holes in the base body is a circle, a diameter of the first area that is on the first end face and that is surrounded by the plurality of holes in the base body ranges from 100 μm to 800 μm, and a diameter of the first area that is on the second end face and that is surrounded by the plurality of holes in the base body ranges from 5 μm to 60 μm; and/or
wherein the plurality of holes are arranged in an array, a diameter of each of the holes on the first end face ranges from 50 μm to 300 μm, and a diameter of each of the holes on the second end face ranges from 0.5 μm to 60 μm; and/or
wherein an anti-reflective film is disposed on a surface of the light concentration member; and/or
wherein the antenna further comprises a supersurface layer, and the supersurface layer is provided between the light concentration member and the first end face; and/or
wherein a plurality of metal particles arranged in an array are provided on the supersurface layer, and a distance between adjacent metal particles ranges from 50 nm to 500 nm.
